(19) United States
(12) Patent Application Publication
(10) Pub. No.: US 2003/0189722 A1
(43) Pub. Date: Oct. 9, 2003

(54) Printing system, printing apparatus, information terminal apparatus, print control method, storage medium, program, printing method and printing program

(75) Inventor: Naohiro Yoshikawa, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/400,501

(22) Filed: Mar. 28, 2003

(30) Foreign Application Priority Data
Apr. 4, 2002 (JP) 102520/2002

(51) Int. Cl. G06F 15/00; B41F 1/00

(52) U.S. Cl. 358/1.15; 358/1.13

(57) ABSTRACT

Function information about a printer is collected, an IP address or port number is assigned to the printer based on the collected function information, an IP address or port number specified by a PDA 101 is identified, and printing is performed by a printer engine 207 by implementing a function of the printer predetermined for the specified IP address or port number. For example, significant inconvenience in designating a paper size adaptable printing function, plural page layout printing function or duplex printing function when implementing direct printing of data in the standard document format is eliminated, and improvement in convenience can be attained.

### BACKGROUND OF THE INVENTION

1. Field of the Invention

The present invention relates to a printing system, a printing apparatus, an information terminal apparatus, a print control method, a storage medium and a program. In particular, it relates to a printing system, a printing apparatus, an information terminal apparatus, a print control method, a storage medium, a program, a printing method and a printing program that are preferable when they are improved in convenience in printing by an apparatus without an advanced printer driver using a printer.

2. Related Background Art

Conventionally, when a printer, such as a laser beam printer (abbreviated as LBP, hereinafter) and a multifunction peripheral with scanner and printer features (abbreviated as MFP, hereinafter), performs printing, the apparatus that causes the printer to perform printing is a computer apparatus in most cases. The “computer apparatus” in this specification comprises a microprocessor system including a CPU, a ROM, a RAM and the like serving as the core of the apparatus, hardware units including a hard disk, a display, a keyboard and a mouse, an operating system (abbreviated as OS, hereinafter) for efficiently operating these hardware units, and application software that runs on the OS and the hardware units which provides a function of word processing, spreadsheet, presentation or the like. This is referred to as PC, hereinafter.

Typically, when a PC transmits print data to a printer for printing, it uses software known as a printer driver. The printer driver is designed to convert a content drawn by application software running on the PC into data suitable for the printer and to make various features of the printer available.

FIGS. 12 to 15 show an example of a display window of a printer driver. The display window is one provided by the printer driver (Ver. 8.30) for the COLOR LASER SHOT LBP-2360 (R), which is a color laser beam printer that runs on the Windows 98 (R), which is an operating system available from Microsoft Corp. In FIG. 12, the “page select” tab 810 of the printer driver is selected. The “page select” tab 810 contains the drop down list 811 for specifying the paper size, the drop down list 812 for specifying the page layout and the like.

If the drop down list 811 for specifying the paper size is operated in FIG. 12, candidates (B5, A4, envelope, postcard and the like) are displayed in a list as shown in FIG. 13, and then, the PC user can specify the desired paper size. As can be seen from FIGS. 12 and 13, it is possible to print an A4-size document onto B5-size paper by scaling down the document or onto A3-size or B4-size paper by scaling up the document, for example. In this specification, this function is referred to as “paper size adaptable printing function”, hereinafter.

Besides, if the drop down list 812 for specifying the page layout is operated in FIG. 12, candidates (and the like) are displayed in a list as shown in FIG. 14, and then, the PC user can specify the desired page layout. As can be seen from FIGS. 12 and 14, it is possible to print a document consisting of plural pages onto one sheet of paper by scaling down the pages of the document to a predetermined size and appropriately arranging the scaled-down pages. In this specification, this function is referred to as “plural page layout printing function”, hereinafter.

In FIG. 15, the “finishing” tab 820 of the printer driver is selected, and the “finishing” tab 820 contains radio buttons 821 for specifying a printing manner. The radio buttons 821 for specifying the printing manner provide candidates of simplex printing, duplex printing and book printing. If the user wants to print a document on both sides of a sheet of paper, he/she can select the duplex printing. In this specification, this function is referred to as “duplex printing function”, hereinafter.

As described above, the “paper size adaptable printing function”, the “plural page layout printing function” and the “duplex printing function” of the printer can be utilized by an appropriate operation in the display window of the printer driver.

On the other hand, in recent years, various formats of electronic documents and various languages to describe electronic documents have been proposed and widely used for information distribution via the Internet or storage media, such as CD-ROM. For example, there are HTML (Hyper Text Markup Language), XML (extensible Markup Language) and PDF (Portable Document Format) . In this specification, a document described in such an electronic document format or in such languages is referred to as “standard document format”, hereinafter.

To browse a document in the “standard document format”, browsing software running on the PC is typically used. In addition, to print the document, the user instructs the browsing software to print the document, the browsing software, the operating system and the printer driver cooperate with each other to convert a content drawn by the browsing software into data suitable for the printer, and then the data is transmitted to the printer. In addition to instructing the browsing software to print the document, the user can instructs, via the display window, the printer driver to adopt the “paper size adaptable printing function”, the “plural page layout printing function” or the “duplex printing function”.

In recent years, documents in the “standard document format” have been used in wider variety of applications. For example, the documents have been used in cellular phones with an information display feature (referred to as cellular phone, hereinafter) or personal digital assistants (abbreviated as PDA, hereinafter). Transportability and portability are essential to the cellular phones and PDAs, and accordingly, they have a user interface inferior to that of PCs in operability. Thus, when a user of a cellular phone or PDA is instructed to print a document, the cellular phone or PDA transmits the data in the standard document format displayed on its screen as it is to the printer for printing. Or, if the document displayed on the screen is obtained via the Internet, the cellular phone or PDA instructs the printer to obtain the uniform resource locator (abbreviated as URL, hereinafter) and perform printing.

In order to perform such printings, recent printers have a function of printing data in the standard document format without a PC or printer driver (referred to as “direct printing function”, hereinafter), or a function of obtaining and printing information associated with a specified URL (referred to as “reference printing function”, hereinafter).

However, the prior art described above has the following problem. That is, when a cellular phone or PDA instructs a printer with the “direct printing function” or “reference printing function” to perform direct printing or reference printing, the user cannot designate the “paper size adaptable printing function”, the “plural page layout printing function” and the “duplex printing function”, which are designated from a PC via the display window of the printer driver when printing is to be performed. Thus, the user is inconveniently required to designate the relevant function via the manipulation panel of the printer, for example, before designating direct printing.

### SUMMARY OF THE INVENTION

The present invention has been devised in view of the circumstances described above. An object of this invention is to eliminate significant inconvenience in designating a paper size adaptable printing function, plural page layout printing function or duplex printing function when performing direct printing of data in the standard document format, thereby providing a printing system, a printing apparatus, an information terminal apparatus, a print control method, a storage medium, a program, a printing method and a printing program which are improved in convenience.

In order to attain the object described above, the present invention provides a printing system that communicably connects a printing apparatus and an information terminal apparatus to each other, in which the printing apparatus assigns to the printing apparatus an identification code based on function information about the printing apparatus and performs printing by implementing a function associated with an identification code specified by the information terminal apparatus, and the information terminal apparatus specifies an identification code for identifying the printing apparatus and causes the printing apparatus to perform printing.

Furthermore, the present invention provides a printing apparatus capable of communicating with an information terminal apparatus, comprising:

collecting means of collecting function information about the printing apparatus; generating means of generating an identification code based on the collected function information; assigning means of assigning the generated identification code to the printing apparatus; outputting means of outputting the assigned identification code; identifying means of identifying the identification code specified by the information terminal apparatus; and printing means of performing printing by implementing a function of the printing apparatus predetermined for the specified identification code.

Furthermore, the present invention provides an information terminal apparatus capable of communicating with a printing apparatus that performs printing by implementing a function associated with an identification code based on function information thereof, comprising: specifying means of specifying an identification code for identifying the printing apparatus and causing the printing apparatus to perform printing.

### BRIEF DESCRIPTION OF THE DRAWINGS

FIG. 1 is a block diagram showing an arrangement of a printing system according to first and second embodiments of this invention;

FIG. 2A is a block diagram showing an arrangement of a printing apparatus in the printing system according to the first and second embodiments;

FIG. 2B is a block diagram showing an arrangement of a PDA of the printing system according to the first and second embodiments;

FIG. 3 is a flowchart of a processing of generating virtual printing apparatus identification information that allows a printing apparatus in the printing system according to the first and second embodiments to be identified via a network in accordance with the arrangement and function of the printing apparatus;

FIG. 4 is a flowchart of a processing in which the PDA in the printing system according to the first embodiment selects a virtual printing apparatus to which print data is to be transmitted in order to select a desired function of the printing apparatus;

FIG. 5 is a flowchart continued from the flowchart in FIG. 4;

FIG. 6 is a flowchart of a processing in which the printing apparatus in the printing system according to the first embodiment performs printing by selecting a function of the printing apparatus based on information about an IP address for which the received print data is destined;

FIG. 7 is a flowchart continued from the flowchart in FIG. 6;

FIG. 8 is a flowchart of a processing in which the PDA in the printing system according to the second embodiment selects a virtual printing apparatus to which print data is to be transmitted in order to select a desired function of the printing apparatus;

FIG. 9 is a flowchart continued from the flowchart in FIG. 8;

FIG. 10 is a flowchart of a processing in which the printing apparatus in the printing system according to the second embodiment performs printing by selecting a function of the printing apparatus based on information about a port number for which the received print data is destined;

FIG. 11 is a flowchart continued from the flowchart in FIG. 10;

FIG. 12 shows a display window of a printer driver with a “page select” tab being selected;

FIG. 13 shows the display window of the printer driver with the “page select” tab being selected and a drop down list for specifying an output paper size being operated;

FIG. 14 shows the display window of the printer driver with the “page select” tab being selected and a drop down list for specifying a page layout being operated; and

FIG. 15 shows the display window of the printer driver with the “finishing” tab being selected.

### DETAILED DESCRIPTION OF THE PREFERRED EMBODIMENTS

First, embodiments of this invention will be described schematically. According to the embodiments of this invention, in a printing system in which a printing apparatus and an information terminal apparatus are connected to each other in such a manner that they can communicate with each other, the printing apparatus collects information about a function provided in the apparatus, and produces an identification code based on the collected information about the function provided in the apparatus. Furthermore, the printing apparatus produces an identification code for a combination of functions provided in the apparatus which can operate simultaneously and produces no identification code for a combination of functions which cannot operate simultaneously. Then, the printing apparatus provides the identification codes to a data input port thereof and externally outputs the same. The information terminal apparatus gives a print instruction to the printing apparatus by designating an identification code assigned to a desired function or combination of functions. Upon receiving the print instruction information, the printing apparatus identifies the specified identification code and implements printing using the function or combination of functions associated with the specified identification code.

Specifically, the embodiments of this invention eliminate significant inconvenience occurring when a user is to designate “paper size adaptable printing function”, “plural page layout printing function” or “duplex printing function” when a printer implements “direct printing” of data in the standard document format on a PDA or cellular phone in a printing system in which the PDA or cellular phone, which cannot be provided with an advanced printer driver, is connected to the printer in such a manner that they can communicate with each other. The embodiments of this invention will be described in detail below with reference to the drawings.

(First Embodiment)

A printing apparatus of a printing system according to a first embodiment of this invention assigns IP addresses to functions provided therein and a combination of the functions. An information terminal apparatus of the printing system transmits data in the standard document format to be directly printed to an IP address, thereby selecting the function or combination of functions provided in the printing apparatus.

Here, the IP address will be schematically described. The IP address is an abbreviation for Internet Protocol address and is information used to uniquely identify a network device in a TCP/IP network. TCP/IP is an abbreviation for Transmission Control Protocol/Internet Protocol, detailed description of which will be omitted.

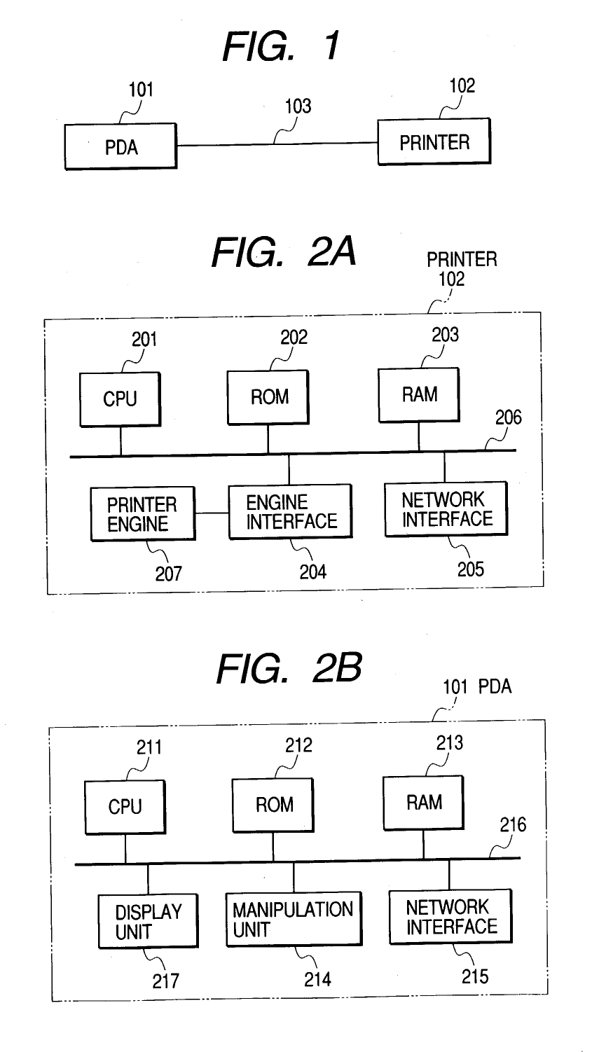

FIG. 1 is a block diagram showing an arrangement of the printing system according to the first embodiment. In FIG. 1, the printing system comprises the information terminal apparatus (PDA 101) and the printing apparatus (printer 102). The PDA 101 and the printer 102 are connected to each other via a network 103. In the first embodiment, the network 103 is a TCP/IP network.

FIGS. 2A and 2B are block diagrams showing arrangements of the printer 102 and PDA 101 in the printing system according to the first embodiment, respectively. In FIG. 2A, the printer 102 comprises a CPU 201, a ROM 202, a RAM 203, and engine interface 204, a network interface 205, a bus 206 and a printer engine 207. In FIG. 2B, the PDA 101 comprises a CPU 211, a ROM 212, a RAM 213, a manipulation unit 214, a network interface 215, a bus 216 and a display unit 217.

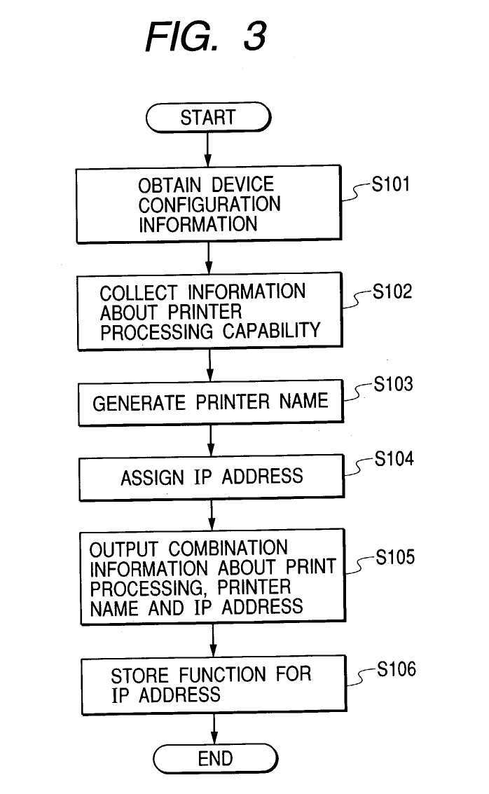

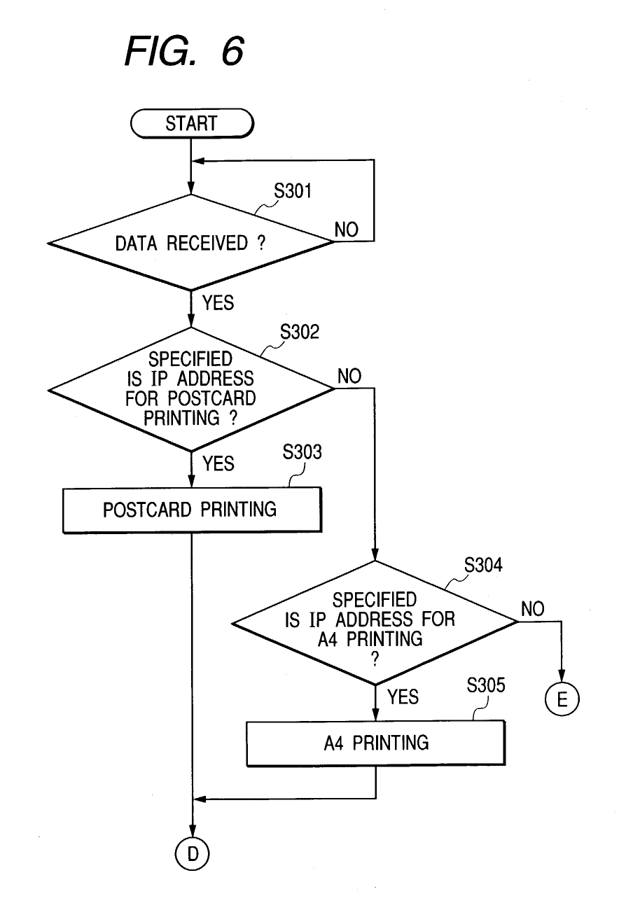

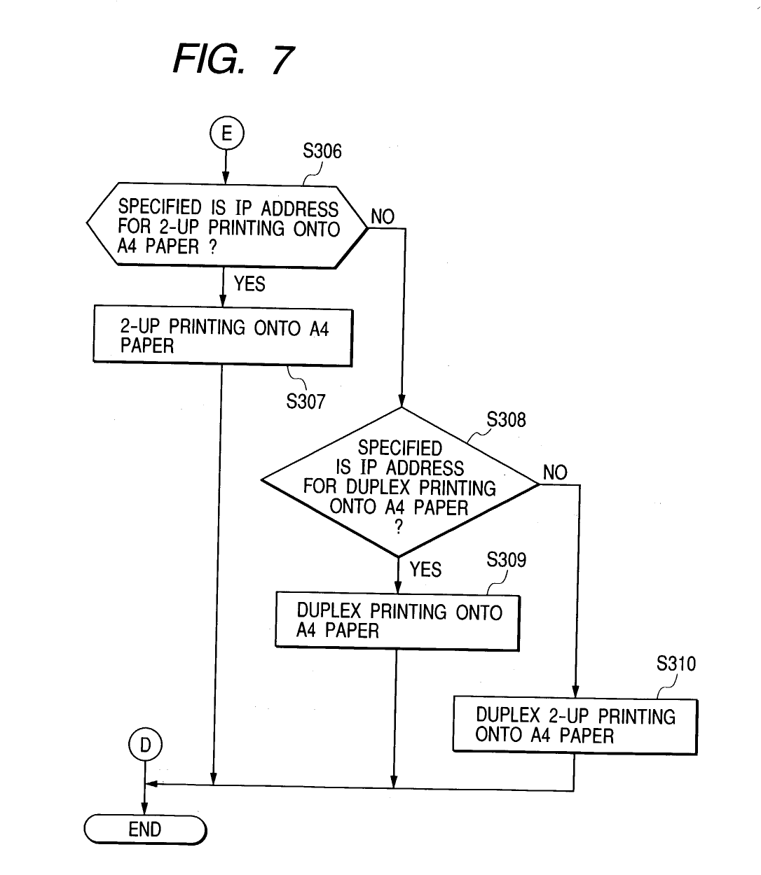

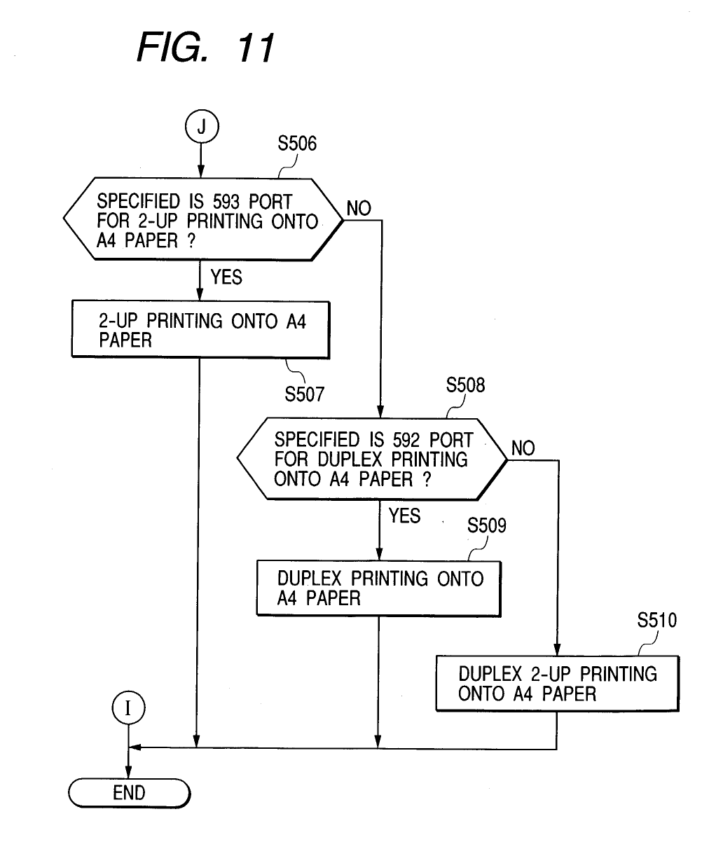

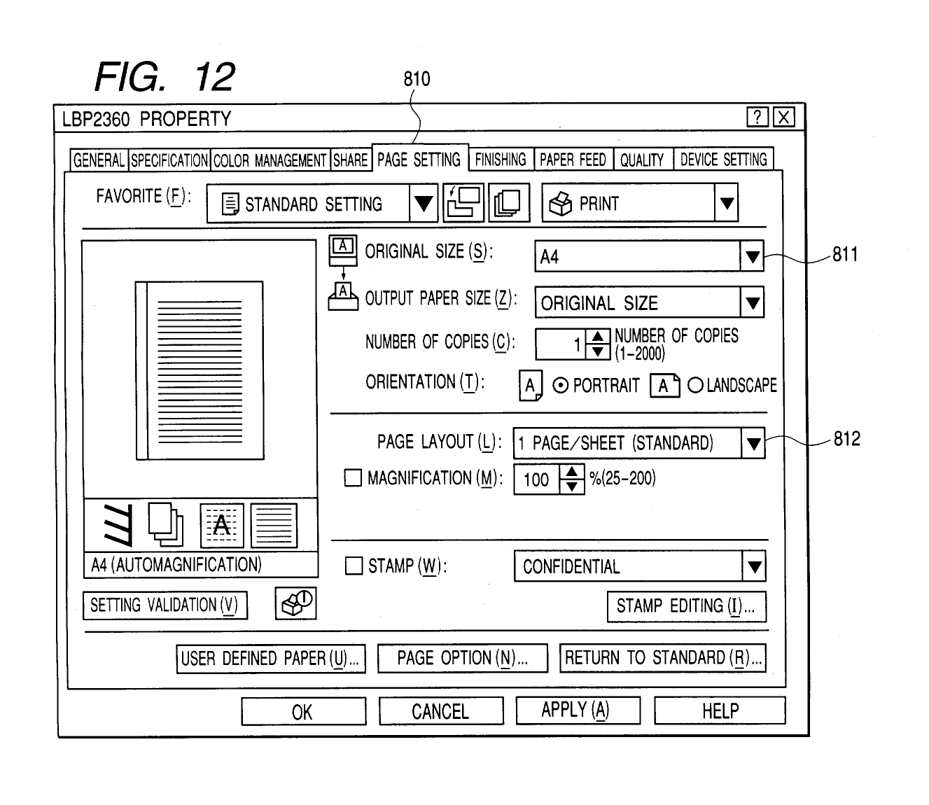

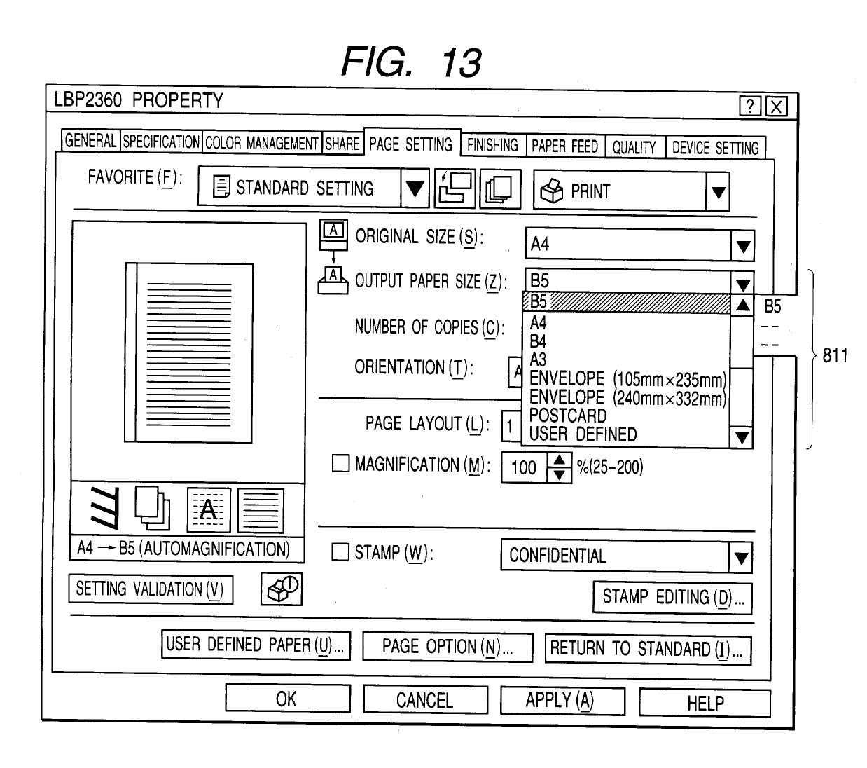

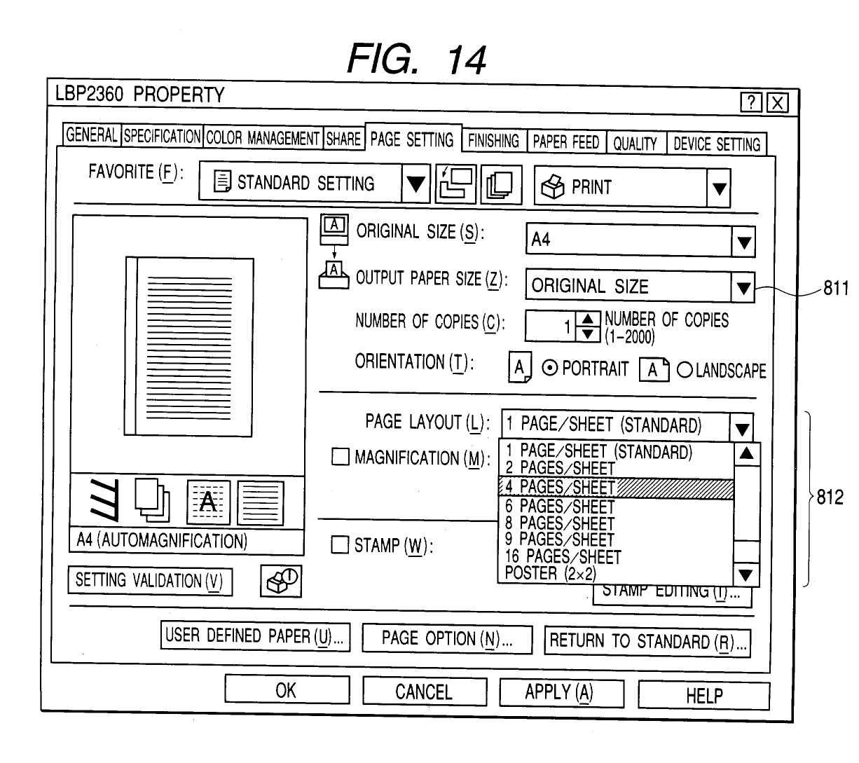

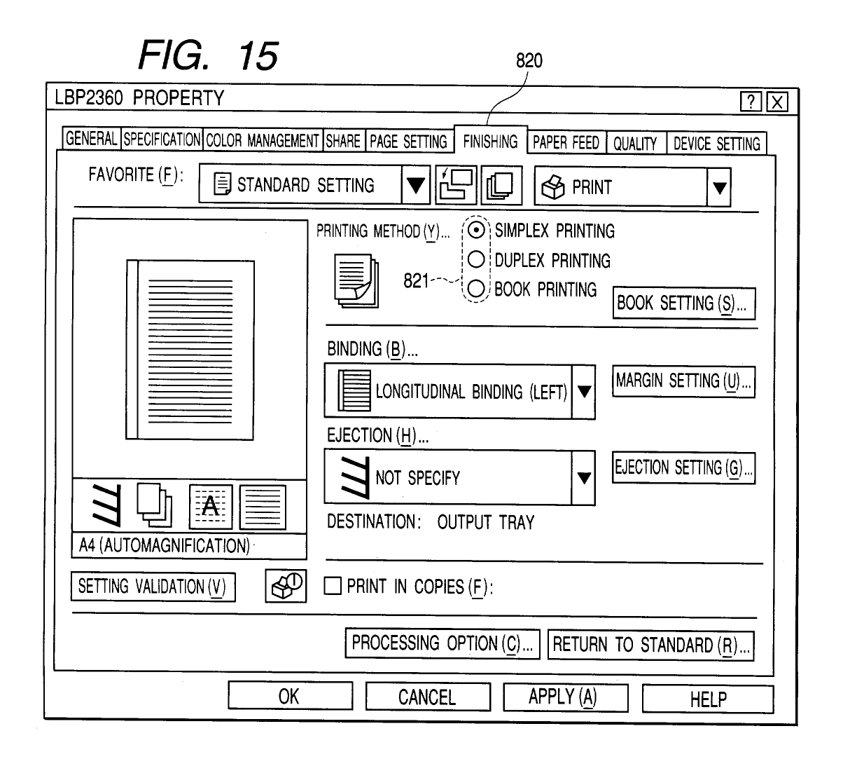

In the printer 102, the CPU 201 is a central processing unit that controls operation of the whole of the printer 102 and performs processings shown in flowcharts in FIG. 3 (first and second embodiments), FIGS. 6 and 7 (first embodiment) and FIGS. 10 and 11 (second embodiment) based on a program stored in the ROM 202 or externally provided. The ROM 202 stores a program on which the CPU 201 runs and data required for the CPU 201 to run. The RAM 203 stores bitmap image data to be printed or intermediate data required for forming a bitmap image during operation of the CPU 201. The RAM 203 includes a nonvolatile RAM (NVRAM) which retains data even after the printer 102 is powered off.

The engine interface 204 transfers the bitmap image in the RAM 203 to the printer engine 207 in the form of a video signal, transmits control information, such as a paper size specifying command and a duplex printing command, to the printer engine 207, or obtains status information from the printer engine 207. The printer engine 207 forms a permanent visible image on a sheet of paper. The network interface 205 receives a print instruction or print data from the PDA 101 via the network 103 interconnecting the printer 102 and the PDA 101 and transmits status information about the printer 102 or the like to the PDA 101 via the network 103. The CPU 201, the ROM 202, the RAM 203, the engine interface 204 and the network interface 205 are connected to each other via the bus 206.

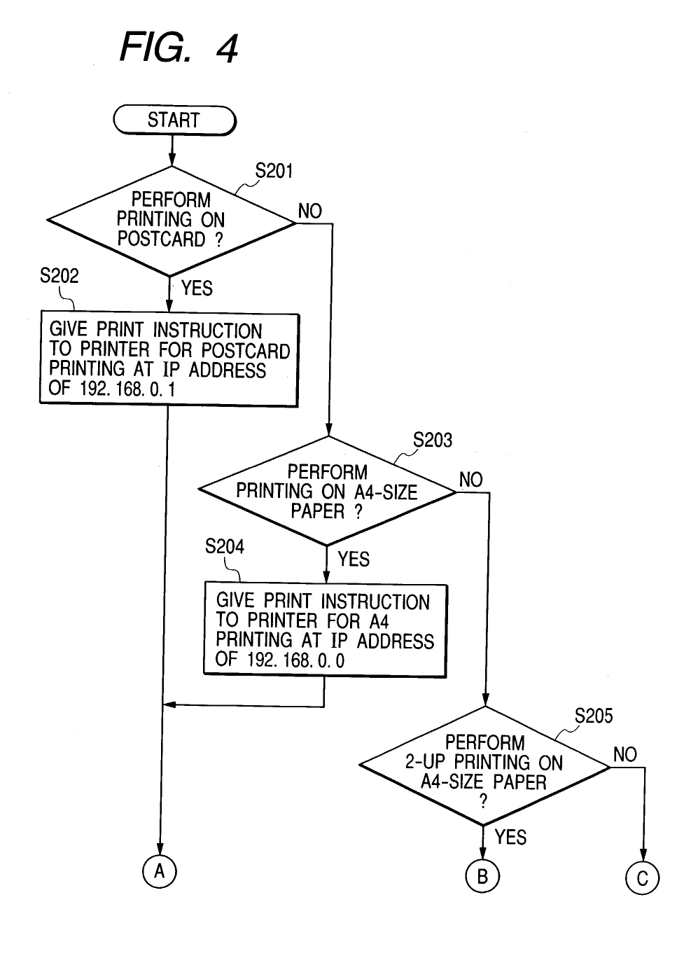

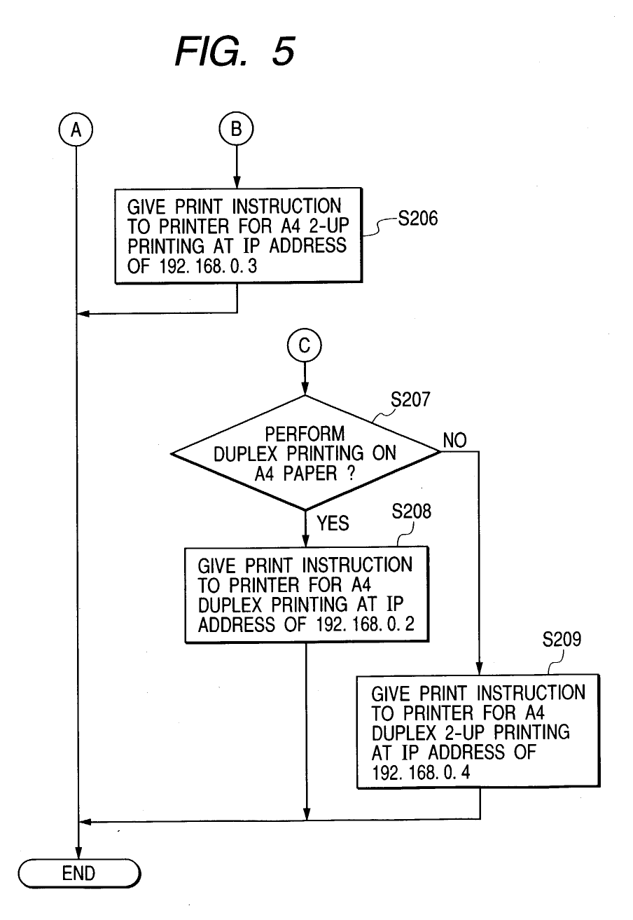

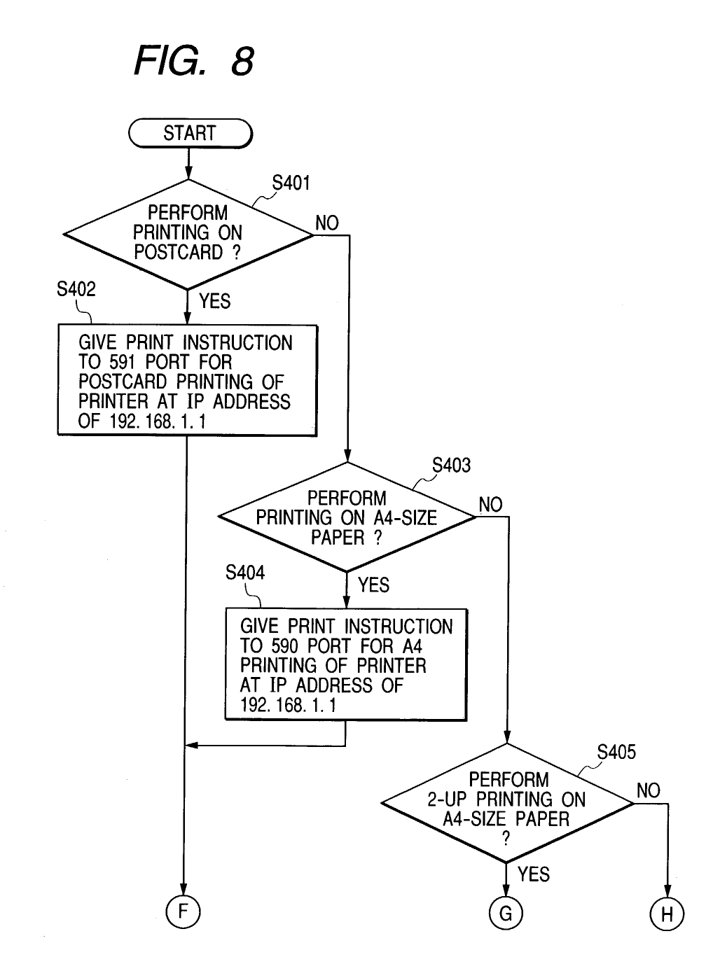

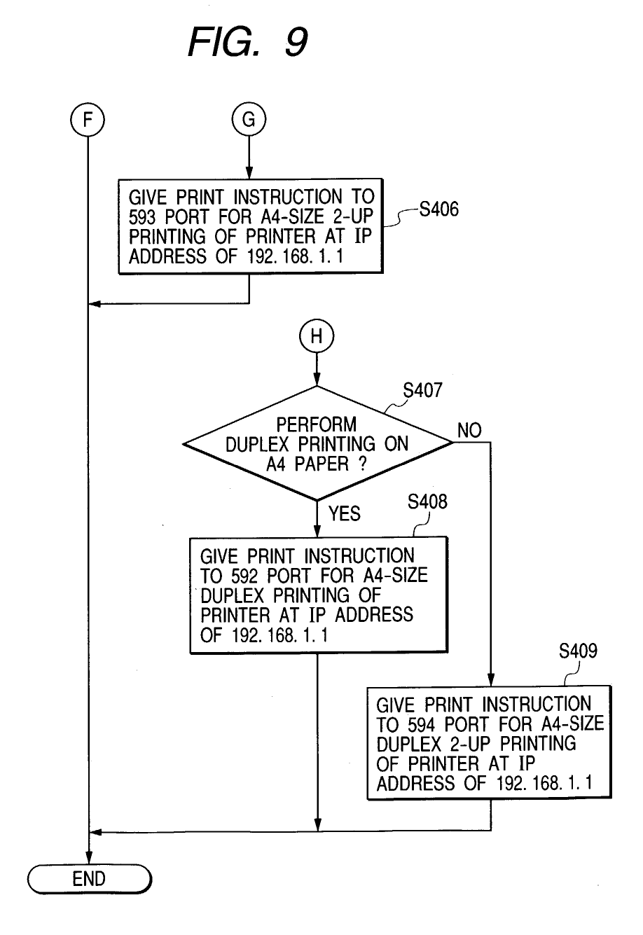

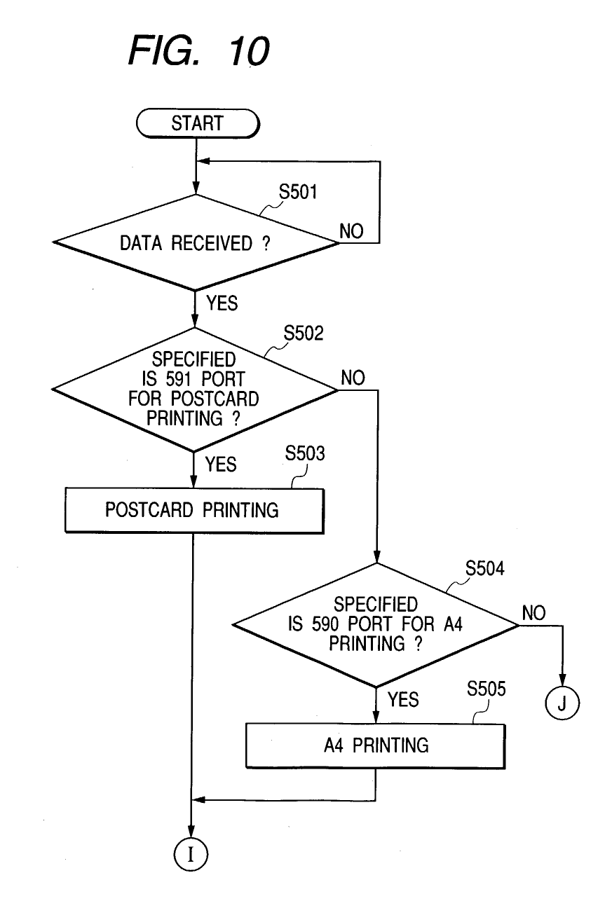

In the PDA 101, the CPU 211 is a central processing unit that controls operation of the whole of the PDA 101 and performs processings shown in flowcharts in FIGS. 4 and 5 (first embodiment) and FIGS. 8 and 9 (second embodiment) based on a program stored in the ROM 212 or externally provided. The ROM 212 stores a program on which the CPU 211 runs and data required for the CPU 211 to run. The RAM 213 serves as a work area or temporary storage area for the CPU 211.

The manipulation unit 214 has various keys for data input, print instruction and the like. The network interface 215 transmits a print instruction or print data to the printer 102 via the network 103 interconnecting the PDA 101 and the printer 102 and receives status information about the printer 102 or the like from the printer 102 via the network 103. The display unit 217 provides various screen displays. The CPU 211, the ROM 212, the RAM 213, the manipulation unit 214, the network interface 215 and the display unit 217 are connected to each other via the bus 216.

Now, operations in the printing system according to the first embodiment thus constructed will be described in detail with reference to FIGS. 1 to 7.

<IP Address Assigning Processing in Printer 102>

First, a processing in which the printer 102 assigns an IP address to a function will be described with reference to the flowchart in FIG. 3. The CPU 201 in the printer 102 obtains device configuration information for the printer 102 (step S101). For example, the device configuration information includes information about presence or absence of a duplex printing unit responsible for duplex printing, presence or absence of an optional paper feed cassette unit mounted to enable the printer to support a wide variety of sizes of paper, and paper sizes set for a standard paper feed cassette, the optional paper feed cassette and a paper feed tray mounted to feed a wide variety of sizes and types of paper.

In the first embodiment, the printer 102 can obtain the information by means of a sensor. In the first embodiment, it is assumed that, as the device configuration information, the information about presence or absence of a duplex printing unit, the information about presence or absence of a paper feed cassette unit, and the information about paper sizes set for the standard paper feed cassette, the optional paper feed cassette and the paper feed tray are obtained. As a result, the following information is obtained.

The printer has a duplex printing unit.

The printer has no optional paper feed cassette.

The paper size for the standard paper feed cassette is A4.

The paper size for the paper feed tray is postcard.

Then, the CPU 201 in the printer 102 obtains information about the processing capability of the printer 102 (step S102). The printer processing capability information is about the paper sizes the printer can handle, the presence or absence of a plural-page layout printing capability, and what number of pages can be laid out in one sheet of paper in the plural-page layout printing. In the first embodiment, the following information is obtained.

The printer can perform printing onto A4 paper.

The printer can perform printing onto a postcard.

The printer can perform plural-page layout printing.

The printer cannot perform plural-page layout printing onto a postcard.

The printer can lay out 2 pages in one sheet of paper in plural-page layout printing.

the printer cannot perform duplex printing onto a postcard.

Then, the CPU 201 in the printer 102 generates a printer name based on the processing capability information (step S103). Since the functions provided in the printer 102 and the combinations of the functions which cannot operate simultaneously are known from the processings in steps S101 and S102, all possible combinations of functions (combinations of paper size of A4 or postcard, duplex or simplex printing, and performance or nonperformance of 2-page layout printing) are listed first, any combination of functions that cannot operate simultaneously is removed therefrom, and then, IP addresses can be assigned to the remaining combinations.

That is, if a character string “A4_” is assigned to the A4 size, a character string “HG_” is assigned to the postcard size, a character string “dup_” is assigned to the duplex printing and a character string “2up” is assigned to the 2-page layout printing, the possible combinations are represented by these character strings as follows:

“A4_”;

“HG_”;

“A4_dup_”;

“HG_dup_”;

“A4_{—}2up”;

“A4_dup_{—}2up”;

“HG_{—}2up”; and

“HG_dup_{—}2up”.

However, since the printer cannot perform plural-page layout printing onto a postcard, the two character strings of “HG_{—}2up_” and “HG_dup_{—}2up” are removed. In addition, since the printer cannot perform duplex printing onto a postcard, the two character strings of “HG_dup_” and “HG_dup_{—}2up” are removed. However, the character string “HG_dup_{—}2up” has been already removed.

After that, the following printer names remain.

“A4_”;

“HG_”;

“A4_dup_”;

“A4_{—}2up”; and

“A4_dup_{—}2up”;

Then, the CPU 201 in the printer 102 successively assigns IP addresses to the printer names (step S104). In the first embodiment, it is assumed that available IP addresses are previously known, and IP addresses of 192.168.0.0 to 192.168.0.4 are to be successively assigned.

Then, the CPU 201 in the printer 102 prints out combination information about a print processing, a printer name and an IP address (step S105). In this printout, a list of combinations of a print processing, a printer name and an IP address, each combination being one record, is printed out. An exemplary list is as follows:

print processing/printer name/IP address

printing onto A4 paper/A4_{—}/192.168.0.0

printing onto postcard/HG_{—}/192.168.0.1

duplex printing onto A4 paper/A4_dup_{—}/192.168.0.2

2-page layout printing onto A4 paper/A4_{—}2up/192.168.0.3

duplex 2-page layout printing onto A4 paper/A4_dup_{—}2up/192.168.0.4

Then, the CPU 201 in the printer 102 stores the functions associated with the respective IP addresses in the printer 102 (step S106) . In this storage, a NVRAM (not shown) in the RAM 103 in the printer 102 is used, and thus, the association of the printer names with the respective functions can be kept even after the printer is powered down and powered up again.

After these processings, to the PDA 101, there seems to be five printers 102 connected thereto via the network 103 including:

the printer that performs A4 printing and is located at the IP address of 192.168.0.0;

the printer that performs postcard printing and is located at the IP address of 192.168.0.1;

the printer that performs A4 duplex printing and is located at the IP address of 192.168.0.2;

the printer that performs A4 2-page layout printing and is located at the IP address of 192.168.0.3; and

the printer that performs A4 duplex 2-page layout printing and is located at the IP address of 192.168.0.4.

<Processing of Instructing Printing from PDA 101 >

Now, a processing of instructing printing from the PDA 101 to the printer 102 will be described with reference to the flowcharts in FIGS. 4 and 5. In the first embodiment, the PDA 101 has previously stored therein the list of the print processings, printer names and IP addresses that is output in step S105 in FIG. 3, and can implement printing onto A4 paper by selecting the “printer that performs A4 printing” if A4 printing is to be performed. The print data can be transmitted from the PDA 101 to the printer 102 according to the LPR protocol (Line Printer Daemon Protocol), which is normally used for transmitting print data in the TCP/IP network.

When the PDA 101 starts the processing of instructing the printer 102 to perform printing, the CPU 211 in the PDA 101 checks whether the printing to be performed by the printer 102 is printing onto a postcard or not (step S201). If the printing to be performed by the printer 102 is printing onto a postcard (if yes in step S201), the CPU 211 in the PDA 101 instructs the printer 102 named “HG_” located at the IP address 192.168.0.1, which is to perform postcard printing, to perform printing via the network interface 215 (step S202). On the other hand, if the printing to be performed by the printer 102 is not printing onto a postcard (if no in step S201), the CPU 211 in the PDA 101 checks whether the printing to be performed by the printer 102 is printing onto A4 paper or not (step S203).

If the printing to be performed by the printer 102 is printing onto A4 paper (if yes in step S203), the CPU 211 in the PDA 101 instructs the printer 102 named “A4_” located at the IP address 192.168.0.0, which is to perform A4 printing, to perform printing via the network interface 215 (step S204). On the other hand, if the printing to be performed by the printer 102 is not printing onto A4 paper (if no in step S203), the CPU 211 in the PDA 101 checks whether the printing to be performed by the printer 102 is 2-page layout printing onto A4 paper or not (step S205).

If the printing to be performed by the printer 102 is 2-page layout printing onto A4 paper (if yes in step S205), the CPU 211 in the PDA 101 instructs the printer 102 named “A4_{—}2up” located at the IP address 192.168.0.3, which is to perform 2-page layout printing onto A4 paper, to perform printing via the network interface 215 (step S206). On the other hand, if the printing to be performed by the printer 102 is not 2-page layout printing onto A4 paper (if no in step S205), the CPU 211 in the PDA 101 checks whether the printing to be performed by the printer 102 is duplex printing onto A4 paper or not (step S207).

If the printing to be performed by the printer 102 is duplex printing onto A4 paper (if yes in step S207), the CPU 211 in the PDA 101 instructs the printer 102 named “A4_dup_” located at the IP address 192.168.0.2, which is to perform duplex printing onto A4 paper, to perform printing via the network interface 215 (step S208) . On the other hand, if the printing to be performed by the printer 102 is not duplex printing onto A4 paper (if no in step S207), the CPU 211 in the PDA 101 instructs the printer 102 named “A4_dup_{—}2up” located at the IP address 192.168.0.4 to perform printing via the network interface 215 in order to implement duplex 2-page layout printing onto A4 paper (step S209).

<Processing Performed if Printer 102 Receives Print Data>

Now, processing performed if the printer 102 receives print data from the PDA 101 will be described with reference to the flowcharts in FIGS. 6 and 7. The CPU 201 in the printer 102 waits for print data to come from the PDA 101. If the printer 102 receives print data from the PDA 101 via the network interface 205, it checks to which IP address the received print data is transmitted (step S301). In the first embodiment, it is assumed that the network interface 205 in the printer 102 is assigned a plurality of IP addresses and can handle data transmitted to the respective addresses.

If the IP address for which the print data received in step S301 is destined is the IP address for postcard printing (192.168.0.1 in the first embodiment) (if yes in step S302), the CPU 201 in the printer 102 prints the received print data onto a postcard by means of the printer engine 207 (step S303). On the other hand, if the IP address for which the received print data is destined is not the IP address for postcard printing (if no in step S302), the CPU 201 in the printer 102 checks whether the IP address for which the received print data is destined is the IP address for A4 printing (192.168.0.0 in the first embodiment) or not (step S304).

If the IP address for which the received print data is destined is the IP address for A4 printing (if yes in step S304), the CPU 201 in the printer 102 prints the received print data onto A4 paper by means of the printer engine 207 (step S305). On the other hand, if the IP address for which the received print data is destined is not the IP address for A4 printing (if no in step S304), the CPU 201 in the printer 102 checks whether the IP address for which the received print data is destined is the IP address for 2-page layout printing onto A4 paper (192.168.0.3 in the first embodiment) or not (step S306).

If the IP address for which the received print data is destined is the IP address for 2-page layout printing onto A4 paper (if yes in step S306), the CPU 201 in the printer 102 performs 2-page layout printing of the received print data onto A4 paper by means of the printer engine 207 (step S307) On the other hand, if the IP address for which the received print data is destined is not the IP address for 2-page layout printing onto A4 paper (if no in step S306), the CPU 201 in the printer 102 checks whether the IP address for which the received print data is destined is the IP address for duplex printing onto A4 paper (192.168.0.2 in the first embodiment) or not (step S308).

If the IP address for which the received print data is destined is the IP address for duplex printing onto A4 paper (if yes in step S308), the CPU 201 in the printer 102 performs duplex printing of the received print data onto A4 paper by means of the printer engine 207 (step S309) . On the other hand, if the IP address for which the received print data is destined is not the IP address for duplex printing onto A4 paper (if no in step S308), the IP address for which the received print data is destined is the IP address for duplex 2-page layout printing onto A4 paper (192.168.0.4 in the first embodiment), and thus, the CPU 201 in the printer 102 performs duplex 2-page layout printing of the received print data onto A4 paper by means of the printer engine 207 (step S310).

As described above, according to the first embodiment, if the present invention is applied to a printing system comprising a PDA and a printer, a virtual name is assigned for each of the functions and combinations of functions provided in any printer. Thus, the functions and combinations of functions provided in the printer can be utilized by the PDA 101 instructing a virtual printer with the virtual name to perform printing. Thus, in particular, significant inconvenience in designating the paper size adaptable printing function, plural page layout printing function or duplex printing function when implementing direct printing of data in the standard document format can be eliminated, and improvement in convenience can be attained. Furthermore, it is obvious that the present invention is effective for the reference printing function.

(Second Embodiment)

A printing apparatus of the printing system according to a second embodiment of this invention is a printing apparatus that communicates with an information terminal apparatus based on TCP/IP and is identified by the IP address thereof on the network. Furthermore, a port number of TCP/IP is assigned to each of the functions and combinations of functions provided in the printing apparatus. The information terminal apparatus of the printing system transmits data in the standard document format to be directly printed to an IP address port number of the printing apparatus, thereby utilizing the function or combination of functions of the printing apparatus.

The TCP/IP port number will be described schematically. In the TCP/IP protocol, each network device is identified by its IP address. However, in an upper level protocol (service), each network device is identified by its port number. For example, port numbers 23 and 21 are assigned to telnet (telecommunication network) and ftp (file transfer protocol), respectively, which are well-known protocols on TCP/IP. In the second embodiment, port numbers 1590 to 1594, which are not used for such well-known protocols, are used. Furthermore, in the second embodiment, for convenience of explanation, it is assumed that the IP address of the printing apparatus is 192.168.1.1.

The whole configuration of the printing system (see FIG. 1) and the block configurations of the printing apparatus (printer 102) and the information terminal apparatus (PDA 101) (see FIGS. 2A and 2B) described in the second embodiment are exactly the same as those described in the first embodiment. Thus, the description thereof will be omitted.

Now, operations in the printing system according to the second embodiment constructed as described above will be described in detail with reference to FIGS. 1 to 3 and 8 to 11.

<Port Number Assigning Processing in Printer 102>

First, a processing in which the printer 102 assigns a port number to a function will be described. The processing of assigning a port number is quite similar to the processing of assigning an IP address to a function described above with reference to the flowchart in FIG. 3 in the first embodiment. In this processing, instead of the IP address, a port number is assigned to a function in step S104. Instead of the combination information about the print processings, printer names and IP addresses, combination information about print processings, printer names and port numbers is output in step S105. Instead of storing the functions associated with the IP addresses in the printer 102, the functions associated with the respective port numbers are stored in the printer 102 in step S106. Thus, the description of this processing will be omitted.

Since the ports numbers are successively assigned to the functions instead of the IP addresses as described above, in the second embodiment, a list of combinations of a print processing, a printer name and a port number, each combination being one record, is output in step S105. For example, the following list is output.

print processing/printer name/port number

printing onto A4 paper/A4_{—}/0

printing onto postcard/HG_{—}/1

duplex printing onto/A4_dup_{—}/2

2-page layout printing onto A4 paper/A4_{—}2up/3

duplex 2-page layout printing onto A4 paper/A4_dup_{—}2up/4

After that, in the printing system according to the second embodiment, to the PDA 101, there seems to be five printers 102 connected thereto via the network 103 including:

the printer that performs A4 printing and is located at the IP address of 192.168.1.1 and assigned a port number 1590;

the printer that performs postcard printing and is located at the IP address of 192.168.1.1 and assigned a port number 1591;

the printer that performs A4 duplex printing and is located at the IP address of 192.168.1.1 and assigned a port number 1592;

the printer that performs A4 2-page layout printing and is located at the IP address of 192.168.1.1 and assigned a port number 1593; and

the printer that performs A4 duplex 2-page layout printing and is located at the IP address of 192.168.1.1 and assigned a port number 1594.

<Processing of Instructing Printing from PDA 101 >

Now, a processing of instructing printing from the PDA 101 to the printer 102 will be described with reference to the flowcharts in FIGS. 8 and 9. In the second embodiment, the PDA 101 has previously stored therein the list of the print processings, printer names and port numbers, which is output in a processing equivalent to step S105 in the first embodiment shown in FIG. 3, and can implement printing onto A4 paper by selecting the “printer that performs A4 printing” if A4 printing is to be performed.

When transmitting the print data from the PDA 101 to the printer 102, the data to be printed can be destined for each port number assigned to the network interface 205 of the printer 102. In this case, unlike the first embodiment described above, the LPR protocol cannot be used. This is because the LPR protocol has already been assigned a port number 515, which is different from the port numbers used in the second embodiment.

When the PDA 101 starts the processing of instructing the printer 102 to perform printing, the CPU 211 in the PDA 101 checks whether the printing to be performed by the printer 102 is printing onto a postcard or not (step S401). If the printing to be performed by the printer 102 is printing onto a postcard (if yes in step S401), the CPU 211 in the PDA 101 instructs the printer 102 which is named “HG_”, assigned the port number 1591 and located at the IP address of 192.168.1.1, which is to perform postcard printing, to perform printing via the network interface 215 (step S402). On the other hand, if the printing to be performed by the printer 102 is not printing onto a postcard (if no in step S401), the CPU 211 in the PDA 101 checks whether the printing to be performed by the printer 102 is printing onto A4 paper or not (step S403).

If the printing to be performed by the printer 102 is printing onto A4 paper (if yes in step S403), the CPU 211 in the PDA 101 instructs the printer 102 which is named “A4_”, assigned the port number 1590 and located at the IP address of 192.168.1.1, which is to perform A4 printing, to perform printing via the network interface 215 (step S404). On the other hand, if the printing to be performed by the printer 102 is not printing onto A4 paper (if no in step S403), the CPU 211 in the PDA 101 checks whether the printing to be performed by the printer 102 is 2-page layout printing onto A4 paper or not (step S405).

If the printing to be performed by the printer 102 is 2-page layout printing onto A4 paper (if yes in step S405), the CPU 211 in the PDA 101 instructs the printer 102 which is named “A4_{—}2up”, assigned the port number 1593 and located at the IP address 192.168.1.1, which is to perform 2-page layout printing onto A4 paper, to perform printing via the network interface 215 (step S406). On the other hand, if the printing to be performed by the printer 102 is not 2-page layout printing onto A4 paper (if no in step S405), the CPU 211 in the PDA 101 checks whether the printing to be performed by the printer 102 is duplex printing onto A4 paper or not (step S407).

If the printing to be performed by the printer 102 is duplex printing onto A4 paper (if yes in step S407), the CPU 211 in the PDA 101 instructs the printer 102 which is named “A4_dup_”, assigned the port number 1592 and located at the IP address of 192.168.1.1, which is to perform duplex printing onto A4 paper, to perform printing via the network interface 215 (step S408) . On the other hand, if the printing to be performed by the printer 102 is not duplex printing onto A4 paper (if no in step S407), the CPU 211 in the PDA 101 instructs the printer 102 which is named “A4_dup_{—}2up”, assigned the port number 1594 and located at the IP address of 192.168.1.1 to perform printing via the network interface 215 in order to implement duplex 2-page layout printing onto A4 paper (step S409).

<Processing Performed if Printer 102 Receives Print Data>

Now, processing performed if the printer 102 receives print data from the PDA 101 will be described with reference to the flowcharts in FIGS. 10 and 11. The CPU 201 in the printer 102 waits for print data to come from the PDA 101. If the printer 102 receives print data from the PDA 101 via the network interface 205, it checks to which port the received print data is transmitted (step S501). In the second embodiment, it is assumed that the network interface 205 in the printer 102 is assigned a plurality of port numbers and can handle data transmitted to the respective ports.

If the port number for which the print data received in step S501 is destined is the port number for postcard printing (1591 in the second embodiment) (if yes in step S502), the CPU 201 in the printer 102 prints the received print data onto a postcard by means of the printer engine 207 (step S503) . On the other hand, if the port number for which the received print data is destined is not the port number for postcard printing (if no in step S502), the CPU 201 in the printer 102 checks whether the port number for which the received print data is destined is the port number for A4 printing (1590 in the second embodiment) or not (step S504).

If the port number for which the received print data is destined is the port number for A4 printing (if yes in step S504), the CPU 201 in the printer 102 prints the received print data onto A4 paper by means of the printer engine 207 (step S505) . On the other hand, if the port number for which the received print data is destined is not the port number for A4 printing (if no in step S504), the CPU 201 in the printer 102 checks whether the port number for which the received print data is destined is the port number for 2-page layout printing onto A4 paper (1593 in the second embodiment) or not (step S506).

If the port number for which the received print data is destined is the port number for 2-page layout printing onto A4 paper (if yes in step S506), the CPU 201 in the printer 102 performs 2-page layout printing of the received print data onto A4 paper by means of the printer engine 207 (step S507). On the other hand, if the port number for which the received print data is destined is not the port number for 2page layout printing onto A4 paper (if no in step S506), the CPU 201 in the printer 102 checks whether the port number for which the received print data is destined is the port number for duplex printing onto A4 paper (1592 in the second embodiment) or not (step S508).

If the port number for which the received print data is destined is the port number for duplex printing onto A4 paper (if yes in step S508), the CPU 201 in the printer 102 performs duplex printing of the received print data onto A4 paper by means of the printer engine 207 (step S509). On the other hand, if the port number for which the received print data is destined is not the port number for duplex printing onto A4 paper (if no in step S508), the port number for which the received print data is destined is the port number for duplex 2-page layout printing onto A4 paper (1594 in the second embodiment), and thus, the CPU 201 in the printer 102 performs duplex 2-page layout printing of the received print data onto A4 paper by means of the printer engine 207 (step S510).

As described above, according to the second embodiment, if the present invention is applied to a printing system comprising a PDA and a printer, a virtual name is assigned for each of the functions and combinations of functions provided in any printer. Thus, the functions and combinations of functions provided in the printer can be utilized by the PDA 101 instructing a virtual printer with the virtual name to perform printing. Thus, in particular, significant inconvenience in designating the paper size adaptable printing function, plural page layout printing function or duplex printing function when implementing direct printing of data in the standard document format can be eliminated, and improvement in convenience can be attained. Furthermore, it is obvious that the present invention is effective for the reference printing function.

(Other Embodiments)

The printing scheme of the printer is not particularly limited by the first and second embodiments. This invention can be applied to various printing scheme including electrophotographic printing, ink jet printing, thermal printing, thermal transfer printing and electrostatic printing.

As an example of the printing apparatus, the printer has been described in the first and second embodiments. However, this invention is not limited to the printer and can be also applied to a multifunction peripheral (MPF) provided with scanner and printer features.

As an example of the information terminal apparatus, the PDA has been described in the first and second embodiments. However, this invention is not limited to the PDA and can be also applied to an information terminal apparatus other than the PDA, a cellular phone or the like which cannot be provided with an advanced printer driver.

In addition, this invention may be applied to a system consisting of a plurality of devices or an apparatus consisting of one device. Of course, this invention can be implemented in such a manner that a medium, such as a storage medium, that stores a program code of software for implementing the functions of the embodiments described above is provided in the system or apparatus, and a computer (or CPU or MPU) in the system or apparatus read the program code stored in the medium, such as a storage medium, to implement the same.

In this case, the program code itself read from the medium, such as a storage medium, implements the functions of the embodiments described above and the medium, such as a storage medium, that stores the program code is included in this invention. As the medium, such as a storage medium, that provides the program code, for example, a floppy® disk, a hard disk, an optical disk, a magneto optical disk, a CD-ROM, a CD-R, a magnetic tape, a nonvolatile memory card, a ROM or the like can be used. Alternatively, the program code can also be downloaded via a network.

In addition, it is needless to say that this invention includes not only a case where the program code read by the computer is executed to implement the functions of the embodiments described above, but also a case where the OS running on the computer or the like implements a part or whole of the actual processings in accordance with an instruction from the program code, thereby implementing the functions of the embodiments described above.

Furthermore, it is needless to say that this invention includes a case where the program code read from the medium, such as a storage medium, is written to a memory provided in an expansion board inserted in the computer or expansion unit connected to the computer, and then a CPU or the like provided in the expansion board or expansion unit implements a part or whole of the actual processings in accordance with an instruction from the program code, thereby implementing the functions of the embodiments described above.

As described above, according to this invention, if this invention is applied to a printing system comprising an information terminal apparatus and a printing apparatus, a virtual identification code (name) is assigned for each of the functions and combinations of functions provided in any printing apparatus. Thus, the functions and combinations of functions provided in the printing apparatus can be utilized by the information terminal apparatus instructing a virtual printing apparatus with the virtual name to perform printing. Thus, in particular, significant inconvenience in designating the paper size adaptable printing function, plural page layout printing function or duplex printing function when implementing direct printing of data in the standard document format can be eliminated, and improvement in convenience can be attained. Furthermore, it is obvious that the present invention is effective for the reference printing function.

What is claimed is:

1. A printing system that communicably connects a printing apparatus and an information terminal apparatus to each other,
wherein said printing apparatus assigns an identification code based on function information about said printing apparatus and performs printing by implementing a function associated with an identification code specified by said information terminal apparatus, and
said information terminal apparatus specifies an identification code and causes said printing apparatus to perform printing.

2. The printing system according to claim 1, wherein said printing apparatus comprises collecting means of collecting the function information about said printing apparatus, means of removing a combination of functions that cannot operate simultaneously based on said collected function information, assigning means of assigning an identification code associated with the removed function information, outputting means of outputting the assigned identification code, identifying means of identifying the identification code specified by said information terminal apparatus, and printing means of performing printing by implementing a function of said printing apparatus predetermined for the specified identification code, and said information terminal apparatus comprises specifying means of specifying an identification code associated with a function to be utilized in said printing apparatus and causing said printing apparatus to perform printing.

3. The printing system according to claim 1, wherein said identification code is assigned to a function provided in said printing apparatus or a combination of functions provided therein.

4. The printing system according to claim 1, wherein said identification code is an IP address of said printing apparatus.

5. The printing system according to claim 1, wherein said identification code is a port number of said printing apparatus.

6. The printing system according to claim 1, wherein said function information includes information about a functional configuration of said printing apparatus, a paper size capable of being handled by said printing apparatus and a printing capability of said printing apparatus.

7. A printing apparatus capable of communicating with an information terminal apparatus, comprising:
collecting means of collecting function information about said printing apparatus;
assigning means of assigning an identification code based on said collected function information;
outputting means of outputting said assigned identification code;
identifying means of identifying the identification code specified by said information terminal apparatus; and
printing means of performing printing by implementing a function of said printing apparatus predetermined for said specified identification code.

8. The printing apparatus according to claim 7, wherein said identification code is assigned to a function provided in said printing apparatus or a combination of functions provided therein.

9. The printing apparatus according to claim 7, wherein said identification code is an IP address of said printing apparatus.

10. The printing apparatus according to claim 7, wherein said identification code is a port number of said printing apparatus.

11. The printing apparatus according to claim 7, wherein said function information includes information about a functional configuration of said printing apparatus, a paper size capable of being handled by said printing apparatus and a printing capability of said printing apparatus.

12. The printing apparatus according to claim 7, wherein the printing apparatus has a paper size adaptable printing function that allows printing of a document onto a plurality of sizes of paper by scaling up or scaling down the document, a plural page layout printing function that allows printing of plural pages of a document onto one sheet of paper and a duplex printing function that allows printing of a document onto both sides of a sheet of paper.

13. An information terminal apparatus capable of communicating with a printing apparatus that performs printing by implementing a function associated with an identification code based on function information thereof, comprising:
specifying means of specifying an identification code for identifying said printing apparatus and causing said printing apparatus to perform printing.

14. A print control method in a printing system having a printing apparatus and an information terminal apparatus connected to each other, comprising:
a step of assigning an identification code based on collected function information about the printing apparatus;
a step of identifying a specified identification code; and
a step of performing printing by implementing a processing associated with said specified identification code.

15. A computer-readable storage medium that stores a program for implementing a print control method applied to a printing system having a printing apparatus and an information terminal apparatus connected to each other, wherein the program comprises:
a step of collecting function information about said printing apparatus;
a step of assigning an identification code based on said collected function information about the printing apparatus;
a step of identifying a specified identification code; and
a step of performing printing by implementing a processing associated with said specified identification code.

16. A printing method, comprising:
a step of assigning an IP address to a printing function; and
a printing step of performing printing using a printing function associated with a specified IP address when print data is received.

17. A printing apparatus, comprising:
storage means of storing an association between a printing function and an IP address; and
printing means of performing printing using a printing function associated with a specified IP address when print data is received.

18. A printing program, comprising:
a step of assigning an IP address to a printing function; and
a printing step of performing printing using a printing function associated with a specified IP address when print data is received.

19. A print control apparatus, comprising:
a storage unit that stores information including an association between a printing function and an IP address;
a selecting unit that selects an IP address associated with a printing function based on the information stored in said storage unit; and
an instructing unit that instructs a printer located at the IP address selected by said selecting unit to perform printing.

20. A print control method, comprising:
a selecting step of selecting an IP address associated with a printing function; and
an instructing step of instructing a printer located at the IP address selected by said selecting step to perform printing.

21. A print control program, comprising:
a selecting step of selecting an IP address associate with a printing function; and
an instructing step of instructing a printer located at the IP address selected by said selecting step to perform printing.
